(19) United States
(12) Patent Application Publication
(10) Pub. No.: US 2026/0131455 A1
(43) Pub. Date: May 14, 2026

(54) ROBOT AND CONTROL METHOD THEREOF

(71) Applicant: Samsung Electronics Co., Ltd., Suwon-si (KR)

(72) Inventor: Injoo KIM, Suwon-si (KR)

(21) Appl. No.: 19/357,829

(22) Filed: Oct. 14, 2025

Related U.S. Application Data
(63) Continuation of application No. PCT/KR2025/012179, filed on Aug. 12, 2025.

(30) Foreign Application Priority Data
Nov. 8, 2024 (KR) 10-2024-0158529

(51) Int. Cl. B25J 9/16; A47L 11/40; B25J 11/00; B25J 13/08

(52) U.S. Cl. CPC B25J 9/161; A47L 11/4008; A47L 11/4061; B25J 9/1664; B25J 11/0085; B25J 13/08

(57) ABSTRACT

A robot is provided. The robot includes at least one sensor, memory, comprising one or more storage media, storing instructions, and one or more processors communicatively coupled to the at least one sensor and the memory, wherein the instructions, when executed by the one or more processors individually or collectively, cause the robot to, based on identifying a liquid contaminant through at least one sensor, identify a cleaning area including the liquid contaminant, based on identifying that the identified cleaning area is a travelable area based on a space map corresponding to a space, obtain sensing data through the at least one sensor while traveling the cleaning area, based on identifying that the cleaning area is a cleanable area based on the obtained sensing data, identify a cleaning path in the cleanable area, and cause the robot to perform cleaning along the cleaning path.

### CROSS-REFERENCE TO RELATED APPLICATION(S)

This application is a continuation application, claiming priority under 35 U.S.C. § 365(c), of an International application No. PCT/KR2025/012179, filed on Aug. 12, 2025, which is based on and claims the benefit of a Korean patent application number 10-2024-0158529, filed on Nov. 8, 2024, in the Korean Intellectual Property Office, the disclosure of which is incorporated by reference herein in its entirety.

### TECHNICAL FIELD

This disclosure relates to a robot and a control method thereof.

### BACKGROUND ART

With the advancement of technologies for cleaning robots, dry-type and wet-type cleaning robots have recently been developed and provided.

Such cleaning robots are electronic devices for performing cleaning automatically while traveling an indoor space. Ordinarily, a cleaning robot has an element for wet-type cleaning in the rear portion thereof to perform wet-type cleaning after dry-type cleaning.

In the case of a cleaning robot cleaning a liquid contaminant, there are times when an instrument of the robot is contaminated with the liquid contaminant, causing deterioration in user satisfaction.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide a robot and a control method thereof.

Additional aspects will be set forth in part in the description which follows and, in part, will be apparent from the description, or may be learned by practice of the presented embodiments.

In accordance with an aspect of the disclosure, a robot is provided. The robot includes at least one sensor, memory, comprising one or more storage media, storing instructions, and one or more processors communicatively coupled to the at least one sensor and the memory, wherein the instructions, when executed by the one or more processors individually or collectively, cause the robot to, based on identifying a liquid contaminant through the at least one sensor, identify a cleaning area including the liquid contaminant, based on identifying that the identified cleaning area is a travelable area based on a space map corresponding to a space, obtain sensing data through the at least one sensor while traveling the cleaning area, based on identifying that the cleaning area is a cleanable area based on the obtained sensing data, identify a cleaning path in the cleanable area, and perform cleaning along the cleaning path.

According to one or more embodiments, the instructions, when executed individually or collectively by the one or more processors, cause the robot to, based on identifying that the cleaning area is a travelable area, identify an exploration area including the cleaning area, and obtain the sensing data through the at least one sensor while traveling the exploration area.

According to one or more embodiments, the instructions, when executed individually or collectively by the one or more processors, cause the robot to identify a contaminated area including the liquid contaminant, and identify the cleaning area including a first margin area within a pre-set distance from the contaminated area.

According to one or more embodiments, the instructions, when executed individually or collectively by the one or more processors, cause the robot to identify a position of the cleaning area in the space map based on sensing data sensed through the at least one sensor, and identify whether the cleaning area is the travelable area based on the position of the cleaning area and obstacle information corresponding to the cleaning area identified from the space map.

According to one or more embodiments, the instructions, when executed individually or collectively by the one or more processors, cause the robot to, based on identifying that the cleaning area is not the travelable area in the space map, identify an obstacle area including an obstacle based on the obstacle information, and re-identify, as the cleaning area, an area excluding the obstacle area from the cleaning area based on the position of the cleaning area and the obstacle area in the space map, and the obstacle area is an area including a second margin area within a pre-set distance from the obstacle.

According to one or more embodiments, the instructions, when executed individually or collectively by the one or more processors, cause the robot to identify the exploration area including a third margin area within a pre-set distance from the cleaning area, obtain sensing data corresponding to an inside of the cleaning area through the at least one sensor while traveling a boundary of the exploration area, and identify whether the cleaning area is the cleanable area based on the obtained sensing data.

According to one or more embodiments, the instructions, when executed individually or collectively by the one or more processors, cause the robot to, based on identifying that the cleaning area is the cleanable area, identify a first cleaning path based on a pre-set travel pattern, and clean the liquid contaminant by traveling the cleaning area rearward based on the identified first cleaning path.

According to one or more embodiments, the instructions, when executed individually or collectively by the one or more processors, cause the robot to, based on identifying an obstacle in the cleaning area based on sensing data obtained through the at least one sensor, identify a second cleaning path based on obstacle information corresponding to the obstacle and the pre-set travel pattern, and control the travel unit to travel the cleaning area rearward along the identified second cleaning path.

According to one or more embodiments, the instructions, when executed individually or collectively by the one or more processors, cause the robot to, based on re-identifying the liquid contaminant on a pre-traveled cleaning path based on sensing data obtained through the at least one sensor while traveling the cleaning area rearward along the first cleaning path, control the travel unit to re-travel on the first cleaning path.

According to one or more embodiments, the instructions, when executed individually or collectively by the one or more processors, cause the robot to identify whether the cleaning area is the cleanable area by traveling the exploration area forward, and based on identifying the cleaning area is the cleanable area, control the travel unit to travel the cleaning area rearward.

According to one or more embodiments, the robot further includes a mopping pad, the at least one sensor is disposed on at least one of a front surface and a lateral surface of the robot to sense a front portion of the robot, and the mopping pad is disposed in a rear portion of the robot.

In accordance with another aspect of the disclosure, a method performed by a robot is provided. The method includes, based on identifying a liquid contaminant, identifying a cleaning area including the liquid contaminant, based on identifying that the identified cleaning area is a travelable area based on a space map corresponding to a space, obtaining sensing data while traveling the cleaning area, based on identifying that the cleaning area is a cleanable area based on the obtained sensing data, identifying a cleaning path in the cleaning area, and causing the robot to perform cleaning along the cleaning path.

In accordance with another aspect of the disclosure, One or more non-transitory computer-readable storage media storing one or more computer programs including computer-executable instructions that, when executed by one or more processors of a robot, cause the robot to perform operations are provided. The operations include, based on identifying a liquid contaminant, identifying a cleaning area including the liquid contaminant, based on identifying that the identified cleaning area is a travelable area based on a space map corresponding to a space, obtaining sensing data while traveling the cleaning area, based on identifying that the cleaning area is a cleanable area based on the obtained sensing data, identifying a cleaning path in the cleaning area, and causing the robot to perform cleaning along the cleaning path.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view provided to explain an operation of a robot according to an embodiment of the disclosure;

FIG. 2 is a block diagram provided to explain a configuration of a robot according to an embodiment of the disclosure;

FIG. 3 is a view provided to explain disposition of elements of a robot according to an embodiment of the disclosure;

FIG. 4 is a view provided to explain an identification process of a cleaning area of a robot according to an embodiment of the disclosure;

FIG. 5 is a view provided to explain an identification process of a travelable area of a robot according to an embodiment of the disclosure;

FIG. 6 is a view provided to explain a re-identification process of a cleaning area of a robot according to an embodiment of the disclosure;

FIG. 7 is a view provided to explain a secondary identification process of a travelable area of a robot according to an embodiment of the disclosure;

FIG. 8 is a view provided to explain an identification process of a first cleaning path of a robot according to an embodiment of the disclosure;

FIG. 9 is a view provided to explain an identification process of a second cleaning path of a robot according to an embodiment of the disclosure;

FIG. 10 is a view provided to explain a re-travel process of a cleaning path of a robot according to an embodiment of the disclosure;

FIG. 11 is a view provided to explain entire operations of a robot according to an embodiment of the disclosure; and

FIG. 12 is a view provided to explain operations of a robot according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms currently widely used are selected as the terms used in the embodiments of the disclosure in consideration of their functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are described in detail in the corresponding descriptions of the disclosure. Therefore, the terms used in the disclosure need to be defined based on meanings thereof and particulars throughout the disclosure rather than simply names thereof.

In the disclosure, the expression "have”, "may have”, "include”, "may include" or the like, indicates the existence of a corresponding feature (e.g., a numerical value, a function, an operation or an element such as a part), and does not exclude the existence of an additional feature.

The expression of at least one from A or/and B is to be understood as indicating any one of “A” or “B” or “A and B”.

The expression “1st”, “2nd”, "first”, "second”, or the like, used in the disclosure, may be used to refer to various elements regardless of their order and/or importance, and may be used merely to differentiate one element from another but not intended to limit corresponding elements thereof.

Based on one element (e.g., a first element) referred to as being “(operatively or communicatively) coupled with/to” or “connected with/to” another element (e.g., a second element), it is to be understood that one element may connect to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, components or combinations thereof but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor (not illustrated) except for a “module” or a “unit” that needs to be implemented by specific hardware.

In the disclosure, the term of user may refer to a person using a robot or an apparatus used by the person.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereafter, one embodiment of the disclosure is described specifically with reference to the accompanying drawings.

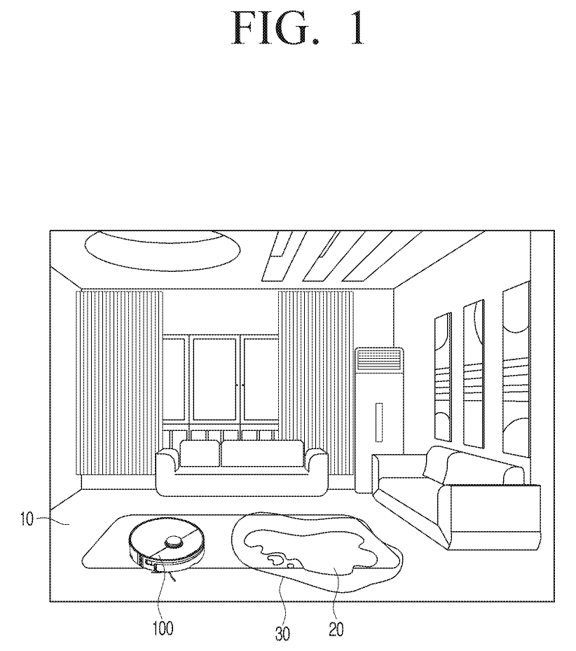

FIG. 1 is a view provided to explain an operation of a robot according to an embodiment of the disclosure.

According to one embodiment, when identifying a liquid contaminant, a robot 100 may set a cleaning path and clean the liquid contaminant while the robot travels a space. Herein, the robot 100 may be a device that performs cleaning while the robot travels on its own by using a driving motor, wheels and the like.

According to one embodiment, the robot 100 may sense a position in a space, the feature of a floor surface, the shape of a space, the positions or shapes of objects (home appliances or furniture and the like) in a space, and the like, by using various types of sensors such as a light detection and ranging (LiDAR) sensor, an infrared sensor, an image sensor, an ultrasonic sensor and the like. FIG. 1 shows that the robot 100 operates in an ordinary home environment 10, but the robot 100 may be used in environments of various places such as an office, a building, a factory, a public office and the like.

According to one embodiment, the robot 100 may identify a liquid contaminant placed on a floor surface (10), based on sensing data sensed through at least one sensor. The liquid contaminant may include contaminants such as water, beverage, a sauce, and urine of a companion animal. When identifying the liquid contaminant, the robot 100 may set a cleaning area including the liquid contaminant.

Referring to FIG. 1, the robot 100 may identify a liquid contaminant 20 through a sensor disposed at the robot 100 while the robot travels a space in a home. When identifying the liquid contaminant 20, the robot 100 may set a cleaning area 30 including the liquid contaminant 20. The robot 100 may identify a cleaning path in the set cleaning area, and clean the liquid contaminant 20 along the identified cleaning path.

As one example, when identifying the liquid contaminant, the robot 100 may clean the liquid contaminant by traveling forward. Ordinarily, at least one sensor for sensing the front portion of the robot 100 and an element for dry-type cleaning may be disposed in the front portion of the robot 100, while an element for wet-type cleaning may be disposed on the rear portion of the robot 100. In the case where the robot 100 travels forward and cleans the liquid contaminant, there may be a problem that a wheel and the element for dry-type cleaning disposed in the front portion of the robot are contaminated with the liquid contaminant.

Hereafter, various embodiments of cleaning of a liquid contaminant based on rearward travel of the robot 100 are described with reference to the drawings.

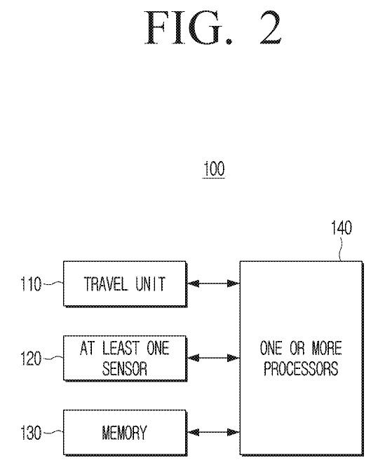

FIG. 2 is a block diagram provided to explain a configuration of a robot according to an embodiment of the disclosure.

Referring to FIG. 2, the robot 100 includes a travel unit 110, at least one sensor 120, memory 130 and one or more processors 140. However, the robot may not be limited thereto, and the robot 100 may be implemented without part of the elements, or implemented with additional elements.

The travel unit 110 is an element for moving a main body of the robot 100. The travel unit 110 may include elements such as a plurality of wheels, a driving motor for rotating each of the plurality of wheels, a gear, a shaft and the like. The plurality of wheels is provided on the lower side or the lateral surface of the main body of the robot 100, and supports the main body of the robot 100 from the floor surface. As the driving motor operates, a driving force of the driving motor is delivered to the plurality of wheels, and each of the wheels rotates, such that the robot 100 may be moved by a frictional force between the floor surface and the wheels. In addition, the travel unit 110 may adjust a rotation speed of at least one of the plurality of wheels differently, or adjust alignment directions of the wheels differently at a time of changing a direction. Instead of the wheels, a continuous track and the like may be used depending on the sort of the robot 100, or weight of a loaded item, or a feature (e.g., roughness, a frictional force and the like of a floor surface) of a space placed by the robot 100.

The at least one sensor 120 is an element for sensing a surrounding environment of the robot 100 and identifying a liquid contaminant. The at least one sensor 120 may include at least one or more of a LiDAR sensor, a depth camera, an inertial measurement unit (IMU) sensor, a time of flight (ToF) sensor, a vision sensor, an optical sensor, a red, green, and blue (RGB) sensor, an image sensor, an infrared sensor, an ultrasonic sensor, a gyro sensor, an acceleration sensor and a proximity sensor.

The LiDAR sensor may project light rays (e.g., a laser, near-infrared light, visible light, ultraviolet rays and the like) to its surroundings at 360 degrees, and detect light reflected by various surrounding objects (e.g., walls, furniture, home appliances and the like) to output sensing information for obtaining information on a distance from the surrounding objects. The depth camera projects a laser or infrared rays to an external object and then receives returning light rays with a stereo camera, measures a distance from the external object three-dimensionally and senses depth data. The IMU sensor, as a sensor for sensing movement of a robot, may include at least one of a geomagnetic sensor, an acceleration sensor and a gyro sensor. The ToF sensor may output a signal such as a laser and the like, and by using time taken to receive a reflective signal thereof (time of flight), measure a distance from an external object.

The memory 130 may store at least one instruction, datum, program and the like required for operations of the robot 100. For example, the memory 130 may store the identified cleaning path in the cleaning area.

The memory 130 may be implemented in the form of memory embedded in the robot 100 or in the form of memory detachable from the robot 100 depending on a data storage purpose. For example, in the case of data for driving the robot 100, the data may be stored in the memory embedded in the robot 100, and in the case of data for an extended function of the robot 100, the data may be stored in memory detachable from the robot 100.

The memory embedded in the robot 100 may be implemented as at least one of volatile memory (e.g., dynamic random access memory (RAM) (DRAM), static RAM (SRAM) or synchronous dynamic RAM (SDRAM), and the like), and non-volatile memory (e.g., one time programmable read only memory (ROM) (OTPROM), programmable ROM (PROM), erasable and programmable ROM (EPROM), electrically erasable and programmable ROM (EEPROM), mask ROM, flash ROM, flash memory (e.g., NAND flash or NOR flash and the like), hard drive, or solid-state drive (SSD).

The memory 130 may be implemented as single memory storing data generated in various operations according to the disclosure, but not limited thereto, and the memory 130 may also be implemented to include a plurality of memories respectively storing different types of data or respectively storing data generated in different steps.

The one or more processors 140 control entire operations of the robot 100. Specifically, the one or more processors 140 may be connected with each element of the robot 100 and control the entire operations of the robot. For example, the one or more processors 140 may be electrically connected with the memory 130 and control the entire operations of the robot 100. The one or more processors 140 may include processing circuitry, and may be comprised of one or a plurality of processors.

The one or more processors 140 may perform the operations of the robot 100 according to the embodiments by executing one or more instructions stored in the memory 130.

The one or more processors 140 may include one or more of a central processing unit (CPU), a graphics processing unit (GPU), an accelerated processing unit (APU), a Many Integrated Core (MIC), a digital signal processor (DSP), a neural processing unit (NPU), a hardware accelerator, or a machine learning accelerator. The one or more processors 140 may control one or any combination of other elements of the robot, and perform an operation in relation to communications or data processing. The one or more processors 140 may execute one or more programs or instructions stored in the memory. For example, the one or more processors may perform a method according to one or more embodiments by executing the one or more instructions stored in the memory.

In the case where the method according to one or more embodiments includes a plurality of operations, the plurality of operations may be performed by one processor or a plurality of processors. For example, at a time when a first operation, a second operation, and a third operation are performed based on the method according to one or more embodiments, the first operation, the second operation and the third operation may all be performed by a first processor, or while the first operation and the second operation may be performed by the first processor (e.g., a general-purpose processor), the third operation may be performed by a second processor (e.g., an artificial intelligence-exclusive processor).

The one or more processors 140 may be implemented as a single-core processor including one core, or one or more multi-core processors including a plurality of cores (e.g., a homogeneous multi core or a heterogeneous multi core). In the case where the one or more processors 140 are implemented as a multi-core processor, each of a plurality of cores included in the multi-core processor may include internal processor memory such as cache memory, and/or on-chip memory, and a common cache shared by the plurality of cores may be included in the multi-core processor. Additionally, each of the plurality of cores (or part of the plurality of cores) included in the multi-core processor may independently perform the method according to one or more embodiments by reading a program instruction for implementing the method, or all (or part) of the plurality of cores may be linked and perform the method according to one or more embodiments by reading a program instruction for implementing the method.

In the case where the method according to one or more embodiments includes a plurality of operations, the plurality of operations may be performed by one of the plurality of cores included in the multi-core processor or by the plurality of cores. For example, at a time when a first operation, a second operation, and a third operation are performed based on the method according to one or more embodiments, the first operation, the second operation and the third operation may all be performed by a first core included in the multi-core processor, or while the first operation and the second operation may be performed by the first core included in the multi-core processor, the third operation may be performed by a second core included in the multi-core processor.

In the embodiments of the disclosure, the processor may denote a system on a chip (SoC) where one or more processors and other electronic components are integrated, a single-core processor, a multi-core processor, or a core included in a single-core processor or a multi-core processor, and herein, the core may be implemented as a CPU, a GPU, an APU, an MIC, a DSP, an NPU, a hardware accelerator or a machine learning accelerator and the like, but the embodiments of the disclosure are not limited thereto. Hereafter, one or more processors 140 are referred to as a processor 140 for convenience of description.

According to one embodiment, when identifying a liquid contaminant through the at least one sensor 120, the processor 140 may identify a cleaning area including the liquid contaminant. The cleaning area may be an area that includes the liquid contaminant and in which the robot 100 performs cleaning.

According to one embodiment, when identifying the identified cleaning area as a travelable area based on a space map corresponding to a space, the processor 140 may obtain sensing data through the at least one sensor 120, during travel of the cleaning area. Herein, the sensing data may include data corresponding to an inside of the cleaning area.

The travelable area may be an area where the robot travels safely while the robot 100 travels a space. For example, the travelable area may be an area where the robot 100 travels safely since there are no obstacles, pillars, steps, high protrusions and walls in the identified cleaning area. For example, the travelable area may be an area where there is no possibility that the robot 100 falls. However, the travelable area is not limited thereto, and the travelable area may be referred to a safe area, an explorable area, or a travel allowable area, but in the disclosure, the areas are collectively referred to as a travelable area.

According to one embodiment, when identifying the cleaning area as a cleanable area based on the obtained sensing data, the processor 140 may identify a cleaning path in the cleaning area.

The cleaning path may be a travel path that is planned for the robot to perform a cleaning task while the robot 100 travels efficiently in the cleaning area. For example, the cleaning path may be a spiral path on which the robot performs cleaning from an outermost area to a central area.

According to one embodiment, the processor 140 may clean the liquid contaminant while traveling on the cleaning path by controlling the travel unit 110.

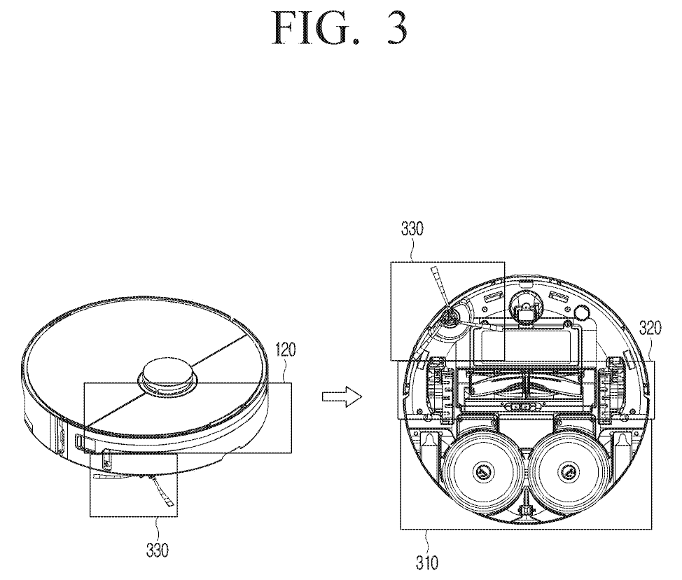

FIG. 3 is a view provided to explain disposition of elements of a robot according to an embodiment of the disclosure.

According to one embodiment, the robot 100 may have at least one sensor, a dust suction opening, and a rotating brush in the front portion thereof, and may have a mapping pad in the rear portion thereof.

As one example, the robot 100 may have the dust suction opening and the rotating brush in the front portion thereof such that the robot may clean dust and foreign substances on the floor surface while the robot travels forward. That is, the robot 100 may have the dust suction opening and the rotating brush in the front portion thereof for dry-type cleaning.

As one example, the robot 100 may have at least one sensor 120 on at least one of the front surface and the lateral surface thereof to sense the front portion of the robot.

As one example, the robot 100 may have the mapping pad in the rear portion thereof for wet-type cleaning after the dry-type cleaning. The mapping pad is an element for cleaning the floor surface by absorbing a liquid contaminant. The mapping pad may be disposed in the rear portion of the robot 100, in contact with a bottom surface of the robot 100.

FIG. 3 shows an upper surface and a lower surface of the robot 100. Referring to FIG. 3, the robot 100 may have at least one sensor 120, a suction opening 320 and a rotating brush 330 in the front portion thereof. The robot 100 may have a mapping pad 310 in the rear portion thereof.

According to one embodiment, in the case where the robot 100 travels forward to clean a liquid contaminant, the suction opening 320 and the rotating brush 330 disposed in the front portion of the robot 100 may be contaminated with the liquid contaminant. In this case, the robot 100 may travel rearward to clean the liquid contaminant through the mapping pad disposed in the rear portion of the robot 100. However, in the case where the robot 100 cleans the liquid contaminant by traveling rearward, at least one sensor 120 may have difficulty in sensing an obstacle in a direction where the robot 100 travels, since the at least one sensor 120 is disposed on the front surface or the lateral surface of the robot 100.

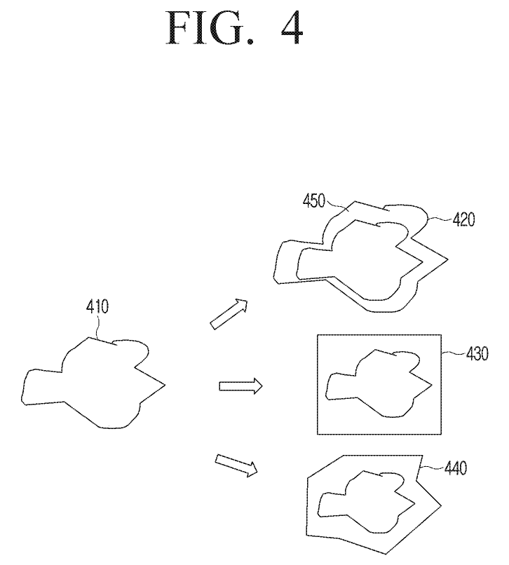

FIG. 4 is a view provided to explain an identification process of a cleaning area of a robot according to an embodiment of the disclosure.

According to one embodiment, the robot 100 may identify a contaminated area including a liquid contaminant, and identify a cleaning area including a first margin area within a pre-set distance from the contaminated area.

As one example, the robot 100 may identify a liquid contaminant placed on the floor surface through at least one of an optical sensor and an RGB sensor.

For example, the robot 100 may radiate light to the floor surface through the optical sensor, and analyze wavelengths of the light meeting and reflecting from the liquid object to identify the liquid contaminant. Wavelengths and intensity of light reflecting from an ordinary floor surface may be constant, but wavelengths and intensity of light meeting and reflecting from a liquid contaminant may be inconstant.

For example, the robot 100 may sense the liquid contaminant placed on the floor surface by comparing the color of the floor surface with the color of the liquid contaminant through an RGB sensor. The robot 100 may identify the color of the liquid contaminant and a boundary between the liquid contaminant and the floor surface through the RGB sensor, and based on a difference in the colors, may identify the liquid contaminant.

Referring to FIG. 4, based on identifying the liquid contaminant through at least one sensor 120, the robot 100 may identify a curve or straight line-shaped contaminated area 410 including the liquid contaminant. The robot 100 may identify a cleaning area 420 including a first margin area 450 within a pre-set distance of 5 cm from the contaminated area.

As one example, the robot 100 may identify a cleaning area in various ways without limiting the cleaning area to the cleaning area 420 illustrated in FIG. 4. For example, the robot 100 may identify a rectangle-shaped cleaning area 430 spaced a pre-set distance apart from an outermost boundary of the contaminated area 410. For example, the robot 100 may identify a polygon-shaped cleaning area including a margin area within a pre-set distance from the contaminated area 410.

Hereafter, the cleaning area 420-440 is limited to a rectangle-shaped cleaning area 430 for convenience of description.

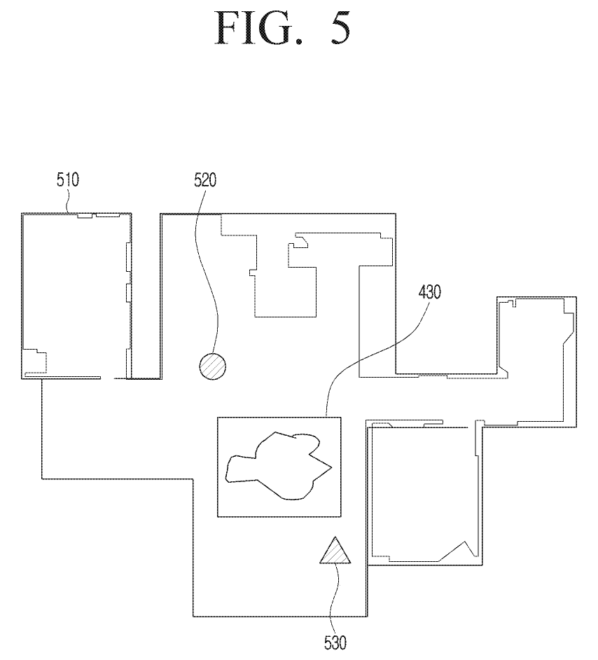

FIG. 5 is a view provided to explain an identification process of a travelable area of a robot according to an embodiment of the disclosure.

According to one embodiment, the robot 100 may identify the position of a cleaning area in a space map based on sensing data sensed through at least one sensor 120.

The robot 100 may obtain a space map while traveling a space placed by the robot 100. The robot 100 may also receive the space map of the space placed by the robot 100 from the user or a server. The space map may include position information on pillars, walls, steps, a spatial structure and an obstacle of the space placed by the robot 100.

According to one embodiment, the robot 100 may primarily identify whether a cleaning area is a travelable area based on the position of the cleaning area and obstacle information corresponding to the cleaning area identified from the space map.

The obstacle information may include information on the position, size, shape and type of an obstacle and a distance of the obstacle from the cleaning area. For example, the obstacle information may include information on the position, size, shape and type of an obstacle placed within a pre-set range from the cleaning area.

Referring to FIG. 5, the robot 100 may identify the position of the cleaning area 430 by sensing the shape of a space around the cleaning area 430, the positions of objects (home appliances or furniture and the like) in the space, and the positions of pillars and walls in the space through the at least one sensor 120.

The robot 100 may identify whether the cleaning area 430 is a travelable area based on the position of the cleaning area 430 and the positions of obstacles 520, 530 around the cleaning area 430 in a space map 510. The robot 100 may identify that the cleaning area 430 is a travelable area as the obstacles 520, 530 around the cleaning area 430 in the space map 510 are spaced a predetermined distance apart from the cleaning area 430.

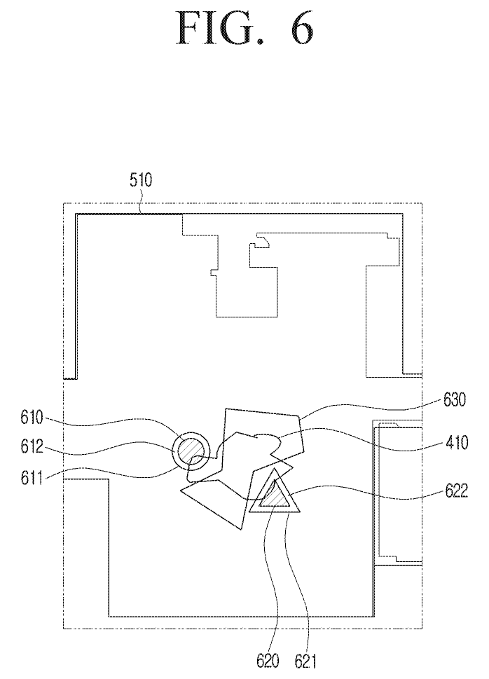

FIG. 6 is a view provided to explain a re-identification process of a cleaning area of a robot according to an embodiment of the disclosure.

According to one embodiment, based on identifying that the cleaning area 430 is not a travelable area in the space map 510, the robot 100 may identify an obstacle area 611, 621 including obstacles based on obstacle information.

The obstacle area 611, 621 may be an area including a second margin area 612, 622 within a pre-set distance from an obstacle 610, 620. The obstacle area 611, 621 may be an area including a safe distance area for preventing the robot 100 from colliding with an obstacle. The obstacle area 611, 621 may not be limited thereto, and may also be referred to as an avoidance area, a safe area, and a protection area, but in the disclosure, may be collectively referred to as an obstacle area.

According to one embodiment, the robot 100 may re-identify, as a cleaning area, an area excluding the obstacle area 611, 621 from the cleaning area 410 based on the position of the cleaning area and the obstacle area 611, 621 in the space map.

Referring to FIG. 6, the robot 100 may identify the position of the obstacle 610, 620 in the space map 510. In the case where the identified position of the obstacle 610, 620 is included in the cleaning area 410, the robot 100 may identify the obstacle area 611, 621 corresponding to each obstacle 610, 620.

The obstacle area 611, 621 may be an area including the second margin area 612, 622 within a pre-set distance (e.g., 10 cm) from the obstacle 610, 620. The robot 100 may re-identify, as a cleaning area 630, an area excluding the obstacle area 611, 612 from the cleaning area 410 based on the identified obstacle area 611, 612.

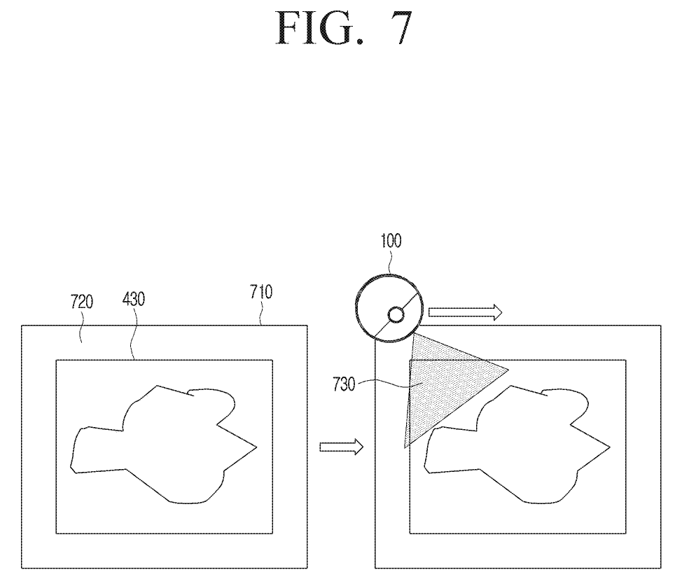

FIG. 7 is a view provided to explain a secondary identification process of a travelable area of a robot according to an embodiment of the disclosure.

According to one embodiment, the robot 100 may identify an exploration area including a third margin area within a pre-set distance from a cleaning area.

According to one embodiment, the robot 100 may obtain sensing data corresponding to the inside of the cleaning area through at least one sensor 120 while traveling the boundary of the exploration area.

The exploration area may be an area in which the robot identifies whether the cleaning area is a travelable area by traveling directly. That is, the robot 100 may set an exploration area surrounding the cleaning area, and identify whether the cleaning area is a travelable area by traveling the boundary of the exploration area directly. The exploration area may not be limited thereto, and may be collectively referred to as a check area, or a previous inspection area. However, the areas are collectively referred to as an exploration area.

According to one embodiment, the robot 100 may secondarily identify whether the cleaning area is a travelable area based on the obtained sensing data. For example, the robot 100 may identify whether there is an obstacle, a pillar, a wall, or a moving object in the cleaning area through the at least one sensor 120 while traveling the boundary of the exploration area.

For example, the robot 100 may secondarily identify whether the cleaning area is a travelable area while traveling the exploration area forward.

Referring to FIG. 7, the robot 100 may identify an exploration area 710 including a third margin area 720 within a pre-set distance (e.g., 5 cm) from the cleaning area 430. The robot 100 may identify the boundary of the identified exploration area 710 and travel the boundary of the exploration area 710.

As one example, the robot 100 may obtain sensing data through the at least one sensor 120 by sensing (730) the inside of the cleaning area 430 while traveling the boundary of the exploration area 710. The robot 100 may identify whether there is an obstacle in the cleaning area 430 through a LiDAR sensor or a depth camera out of the at least one sensor 120.

As one example, based on sensing no obstacle inside the cleaning area 430 while the robot travels the boundary of the exploration area 710, the robot 100 may identify that the cleaning area 430 is a travelable area.

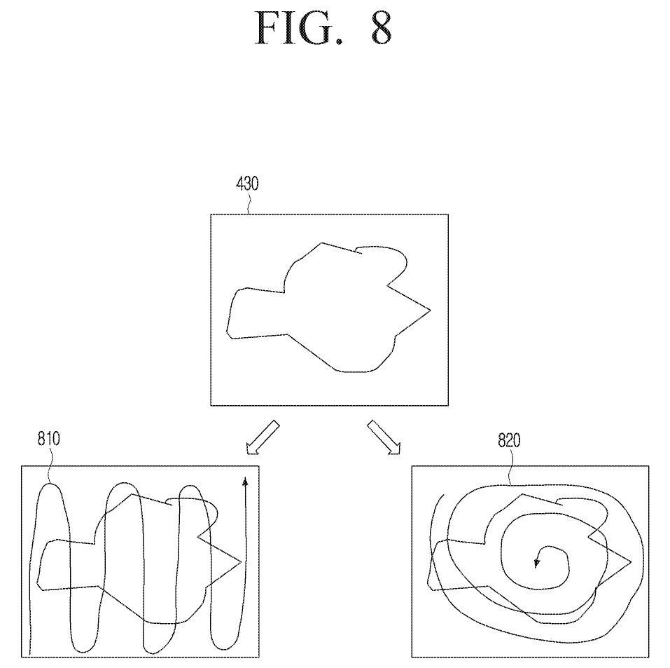

FIG. 8 is a view provided to explain an identification process of a first cleaning path of a robot according to an embodiment of the disclosure.

According to one embodiment, when identifying that the cleaning area is a cleanable area, the robot 100 may identify a first cleaning path based on a pre-set travel pattern.

The pre-set travel pattern may be a travel pattern including a shortest cleaning path for cleaning the cleaning area 430 most efficiently. For example, the pre-set travel pattern may be a spiral travel pattern where cleaning is performed in a direction from the end point of the edge of the cleaning area to the center thereof, or a zigzag travel pattern where cleaning is performed in a direction from the end point of the vertex of the cleaning area to the end point of the diagonal vertex thereof.

According to one embodiment, the robot 100 may clean a liquid contaminant by traveling the cleaning area rearward based on the identified first cleaning path. The robot 100 may move rearward and perform cleaning to clean the liquid contaminant through the mapping pad 310 disposed in the rear portion of the robot 100.

Referring to FIG. 8, when identifying the cleaning area is a cleanable area, the robot 100 may set a cleaning path in a zigzag travel pattern 810 in the cleaning area 430. The robot 100 may also set a cleaning path in a spiral travel pattern 820 different from the zigzag travel pattern 810 in the cleaning area 430. However, the cleaning paths are described merely as examples, and the cleaning paths may be set based on user settings or a pre-set travel pattern.

As one example, the robot 100 may perform cleaning by traveling the cleaning area 430 rearward based on the identified first cleaning path 810, 820.

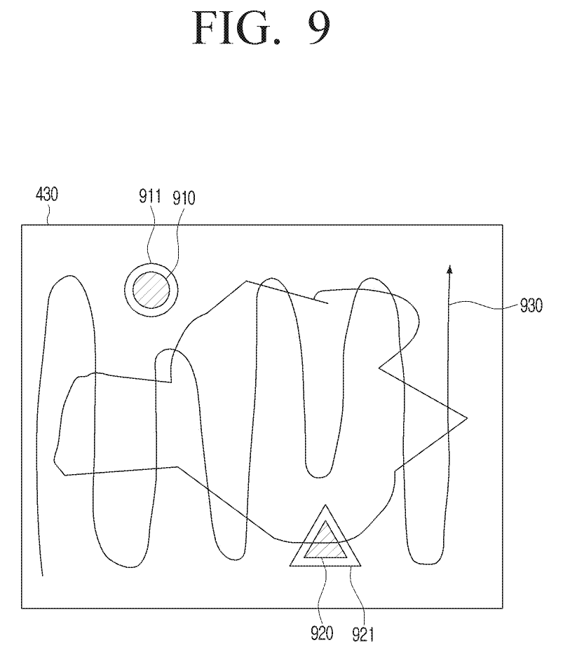

FIG. 9 is a view provided to explain an identification process of a second cleaning path of a robot according to an embodiment of the disclosure.

According to one embodiment, when identifying an obstacle in the cleaning area based on sensing data obtained through the at least one sensor 120, the robot 100 may identify a second cleaning path based on obstacle information corresponding to the obstacle and a pre-set travel pattern.

As one example, based on identifying an obstacle in the cleaning area while the robot 100 travels the boundary of the exploration area 710, the robot 100 may identify an obstacle area corresponding to the identified obstacle. The robot 100 may set the second cleaning path in an area except for the identified obstacle area.

According to one embodiment, the robot 100 may travel rearward along the identified second cleaning path in the cleaning area by controlling the travel unit 110.

Referring to FIG. 9, the robot 100 may identify an obstacle 910, 920 in the cleaning area 430, while traveling the boundary of the exploration area 710. The robot 100 may identify an obstacle area 911, 921 corresponding to each of the identified obstacle 910, 920. The robot 100 may identify a second cleaning path 930 based on the obstacle area 911, 921 and a pre-set travel pattern (e.g., a zigzag travel pattern).

The second cleaning path 930 may be a cleaning path excluding the obstacle area 911, 921 from the first cleaning path 810, 820. The second cleaning path 930 may not be limited thereto, and may also be set based on a different travel pattern.

As one example, the robot 100 may perform cleaning by traveling the cleaning area 430 rearward based on the second cleaning path 930.

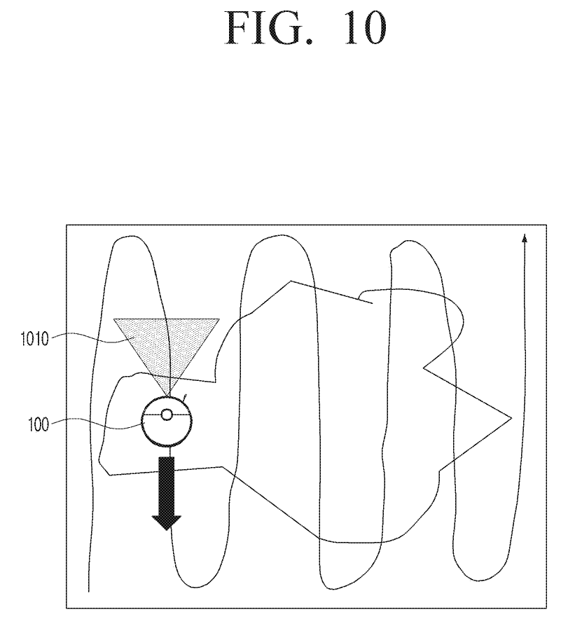

FIG. 10 is a view provided to explain a re-travel process of a cleaning path of a robot according to an embodiment of the disclosure.

According to one embodiment, based on re-identifying a liquid contaminant on a pre-traveled cleaning path based on sensing data obtained through at least one sensor 120, while the robot travels the cleaning area rearward based on the first cleaning path 810, the robot 100 may re-travel on the first cleaning path 810 by controlling the travel unit 110.

As one example, the robot 100 may identify whether a contaminant is on a pre-traveled cleaning path through at least one sensor 120 disposed in the front portion of the robot 100, while traveling on the first cleaning path 810 rearward. When re-identifying the liquid contaminant on the pre-traveled cleaning path, the robot 100 may clean the identified liquid contaminant by re-traveling the first cleaning path.

For example, based on re-identifying the liquid contaminant on the pre-traveled cleaning path, the robot 100 may control the travel unit 110 to perform re-cleaning at a start point of the first cleaning path 810, when performing cleaning along the first cleaning path 810 and reaching the end point of the first cleaning path 810.

Referring to FIG. 10, the robot 100 may clean the liquid contaminant by traveling the cleaning area rearward along the first cleaning path 810. During the rearward travel, the robot 100 may sense 1010 the pre-traveled cleaning area through the at least one sensor 120 disposed in the front portion of the robot 100.

When re-identifying the liquid contaminant on the pre-traveled cleaning path, the robot 100 may clean the re-identified liquid contaminant by re-traveling on the first cleaning path 810.

According to one embodiment, the robot 100 may identify whether an identified cleaning area is a travelable area based on a space map, and secondarily identify whether the cleaning area is a travelable area based on an exploration area. In this case, based on the identified cleaning area being not a travelable area through the space map or the at least one sensor 120, the robot 100 may provide a user notification or alarm.

For example, the robot 100 may provide an alarm notification through a speaker disposed at the robot. For example, the robot 100 may provide a user notification in a pop-up form through a user terminal device communicating with the robot 100. At this time, the robot 100 may provide a user notification for direct cleaning or for re-setting of a cleaning area since the cleaning area is not a travelable area.

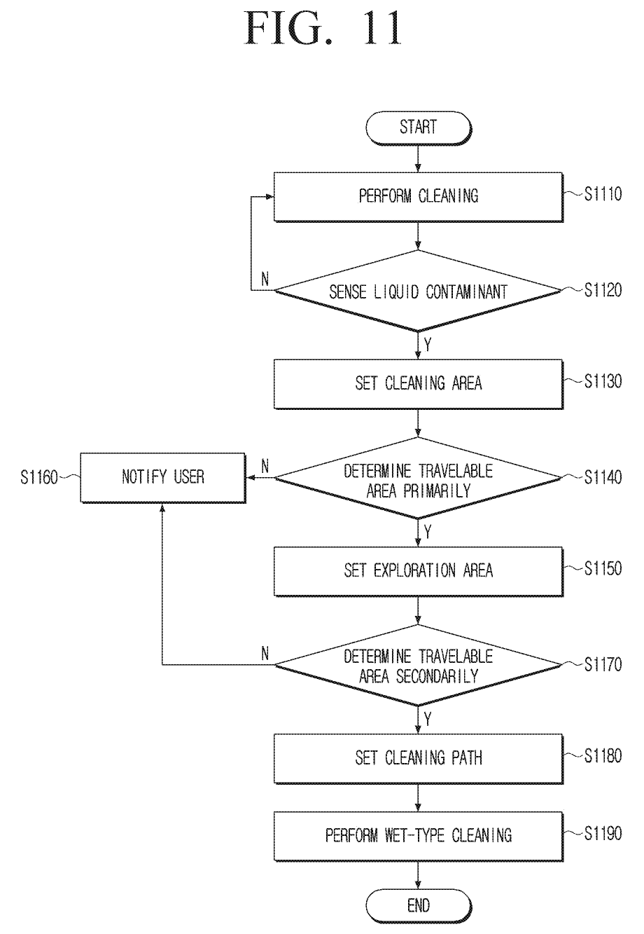

FIG. 11 is a view provided to explain entire operations of a robot according to an embodiment of the disclosure.

Referring to FIG. 11, in operation 1110, the robot 100 may clean a floor surface while traveling a space.

In operation 1120, the robot 100 may identify a liquid contaminant through at least one sensor 120, while traveling the space.

In operation 1130, the robot 100 may set a cleaning area including the identified liquid contaminant.

In operation 1140, the robot 100 may identify whether the identified cleaning area is a travelable area based on a space map corresponding to the space.

In operation 1150, when identifying that the cleaning area is a travelable area, the robot 100 may set an exploration area including the cleaning area.

In operation 1160, in the case where the cleaning area is not a travelable area, the robot 100 may provide a user notification for re-setting of a cleaning area or for direct cleaning.

In operation 1170, the robot 100 may secondarily identify whether the cleaning area is a travelable area by traveling the exploration area.

In operation 1180, when identifying the cleaning area is a cleanable area, the robot 100 may set a cleaning path in the cleaning area.

In operation 1190, the robot 100 may perform wet-type cleaning of the cleaning area based on the set cleaning path.

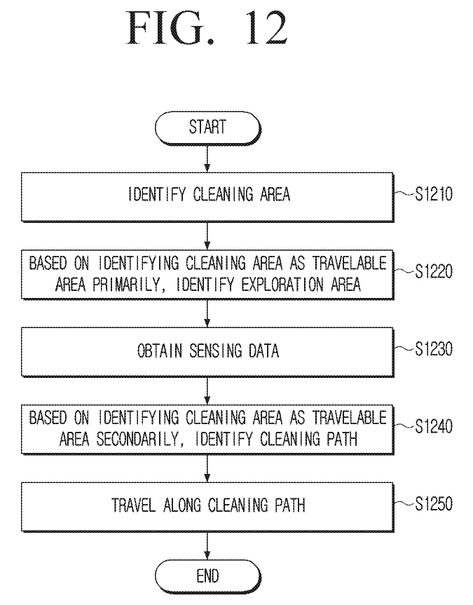

FIG. 12 is a view provided to explain operations of a robot according to an embodiment of the disclosure.

Referring to FIG. 12, in operation 1210, based on identifying a liquid contaminant through at least one sensor 120 while the robot 100 travels a space, the robot 100 may identify a cleaning area including the liquid contaminant.

In operation 1220, based on identifying the identified cleaning area is a travelable area based on a space map corresponding to the space, the robot 100 may identify an exploration area including the cleaning area.

In operation 1230, the robot 100 may obtain sensing data through the at least one sensor 120 while traveling the exploration area.

In operation 1240, based on identifying the cleaning area is a cleanable area based on the obtained sensing data, the robot 100 may identify a cleaning path in the cleaning area.

In operation 1250, the robot 100 may perform cleaning by traveling on the identified cleaning path rearward.

The methods of identifying a cleaning area and an exploration area and identifying whether the cleaning area is a travelable area or a cleanable area are specifically described with reference to the above embodiments, and accordingly, detailed description in relation to this is avoided.

The control method described with reference to FIG. 12 may be performed by a robot 100 having the above-described configuration of FIG. 2, but not necessarily limited thereto, and may also be performed by a robot having various configurations.

The above-described embodiments may be implemented solely, or at least one of the embodiments may be combined partially or entirely and implemented together in one device.

According to the above-described embodiments, the robot 100 may set a cleaning area including a liquid contaminant, set a cleaning path in the cleaning area, and perform wet-type cleaning by traveling along the cleaning path rearward.

Meanwhile, the above-described embodiments may be solely applied to a product, but at least part of the particulars of an embodiment may be combined with another embodiment of the disclosure and implemented together.

The above-described embodiments may be implemented with software including instructions stored in a storage medium readable by a machine (e.g., a computer). The machine, as a device capable of calling the stored instructions from the storage media and operating according to the called instructions, may include an electronic apparatus (e.g., a robot 100) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory computer readable storage medium. Herein, the term “non-transitory” only means that the storage medium includes no signal and is tangible, while the term does not distinguish semi-permanent or temporary storage of data in the storage medium.

Additionally, the methods according to the above-described embodiments described above may be provided in a computer program product.

Specifically, a non-transitory readable storage medium or a computer program product storing computer instructions for, based on identifying a liquid contaminant, identifying a cleaning area including the liquid contaminant, based on identifying that the identified cleaning area is a travelable area based on a space map corresponding to a space, obtaining sensing data while traveling the cleaning area, based on identifying that the cleaning area is a cleanable area based on the obtained sensing data, identifying a cleaning path in the cleaning area, and performing cleaning along the identified cleaning path may be provided.

The computer program product may be distributed in the form of a machine-readable storage medium (e.g., compact disc read only memory (CD-ROM)), or distributed online through an application store (e.g., Play Store^{TM}). In the case of an online distribution, at least part of the computer program product (e.g., a downloadable app) may be stored at least temporarily, or generated temporarily in a storage medium such as a server of a manufacturer, a server of an application store, or memory of a relay server.

Further, computer instructions or programs for performing a control method of a robot and the like according to the above-described embodiments may be stored in a non-transitory computer-readable medium. The computer instructions stored in such a non-transitory computer-readable medium, when executed by the processor of a specific device, causes the specific device to perform processing operations in a device according to the above-described embodiments. The non-transitory computer-readable medium denotes a medium that stores data semi-permanently and is readable by a machine, rather than a medium such as a register, cache, memory and the like that store data temporarily. Specific examples of the non-transitory computer-readable medium may include a CD, a digital versatile disc (DVD), a hard disk, a blue-ray disc, a USB, a memory card, ROM and the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A robot comprising:
at least one sensor;
memory, comprising one or more storage media, storing instructions; and
one or more processors communicatively coupled to the at least one sensor and the memory,
wherein the instructions, when executed by the one or more processors individually or collectively, cause the robot to:
based on identifying a liquid contaminant through the at least one sensor, identify a cleaning area including the liquid contaminant,
based on identifying that the identified cleaning area is a travelable area based on a space map corresponding to a space, obtain sensing data through the at least one sensor while traveling the cleaning area,
based on identifying that the cleaning area is a cleanable area based on the obtained sensing data, identify a cleaning path in the cleaning area, and
cause the robot to perform cleaning along the cleaning path.

2. The robot as claimed in claim 1, wherein the instructions, when executed by the one or more processors individually or collectively, further cause the robot to:
based on identifying that the cleaning area is a travelable area, identify an exploration area including the cleaning area; and
obtain the sensing data through the at least one sensor while traveling the exploration area.

3. The robot as claimed in claim 1, wherein the instructions, when executed by the one or more processors individually or collectively, further cause the robot to:
identify a contaminated area including the liquid contaminant; and
identify the cleaning area including a first margin area within a pre-set distance from the contaminated area.

4. The robot as claimed in claim 1, wherein the instructions, when executed by the one or more processors individually or collectively, further cause the robot to:
identify a position of the cleaning area in the space map based on sensing data sensed through the at least one sensor; and
identify whether the cleaning area is the travelable area based on the position of the cleaning area and obstacle information corresponding to the cleaning area identified from the space map.

5. The robot as claimed in claim 4,
wherein the instructions, when executed by the one or more processors individually or collectively, further cause the robot to:
based on identifying that the cleaning area is not the travelable area in the space map, identify an obstacle area including an obstacle based on the obstacle information, and
re-identify, as the cleaning area, an area excluding the obstacle area from the cleaning area based on the position of the cleaning area and the obstacle area in the space map, and
wherein the obstacle area is an area including a second margin area within a pre-set distance from the obstacle.

6. The robot as claimed in claim 2, wherein the instructions, when executed by the one or more processors individually or collectively, further cause the robot to:
identify the exploration area including a third margin area within a pre-set distance from the cleaning area;
obtain sensing data corresponding to an inside of the cleaning area through the at least one sensor while traveling a boundary of the exploration area; and
identify whether the cleaning area is the cleanable area based on the obtained sensing data.

7. The robot as claimed in claim 1, wherein the instructions, when executed by the one or more processors individually or collectively, further cause the robot to:
based on identifying that the cleaning area is the cleanable area, identify a first cleaning path based on a pre-set travel pattern; and
cause the robot to clean the liquid contaminant by traveling the cleaning area rearward based on the identified first cleaning path.

8. The robot as claimed in claim 7, wherein the instructions, when executed by the one or more processors individually or collectively, further cause the robot to:
based on identifying an obstacle in the cleaning area based on sensing data obtained through the at least one sensor, identify a second cleaning path based on obstacle information corresponding to the obstacle and the pre-set travel pattern; and
travel the cleaning area rearward along the identified second cleaning path.

9. The robot as claimed in claim 7, wherein the instructions, when executed by the one or more processors individually or collectively, further cause the robot to:
based on re-identifying the liquid contaminant on a pre-traveled cleaning path based on sensing data obtained through the at least one sensor while traveling the cleaning area rearward along the first cleaning path, re-travel on the first cleaning path.

10. The robot as claimed in claim 2, wherein the instructions, when executed by the one or more processors individually or collectively, further cause the robot to:
identify whether the cleaning area is the cleanable area by traveling the exploration area forward; and
based on identifying the cleaning area is the cleanable area, travel the cleaning area rearward.

11. The robot as claimed in claim 1 further comprising:
a mopping pad,
wherein the at least one sensor is disposed on at least one of a front surface and a lateral surface of the robot to sense a front portion of the robot, and
wherein the mopping pad is disposed in a rear portion of the robot.

12. A method performed by a robot, the method comprising:
based on identifying a liquid contaminant, identifying a cleaning area including the liquid contaminant;
based on identifying that the identified cleaning area is a travelable area based on a space map corresponding to a space, obtaining sensing data while traveling the cleaning area;
based on identifying that the cleaning area is a cleanable area based on the obtained sensing data, identifying a cleaning path in the cleaning area; and
causing the robot to perform cleaning along the cleaning path.

13. The method as claimed in claim 12, wherein the obtaining of the sensing data further comprises:
based on identifying that the cleaning area is a travelable area, identifying an exploration area including the cleaning area; and
obtaining the sensing data while traveling the exploration area.

14. The method as claimed in claim 12, wherein the identifying of the cleaning area further comprises:
identifying a contaminated area including the liquid contaminant; and
identifying the cleaning area including a first margin area within a pre-set distance from the contaminated area.

15. The method as claimed in claim 12, further comprising:
identifying a position of the cleaning area in the space map based on sensing data sensed through at least one sensor; and
identifying whether the cleaning area is the travelable area based on the position of the cleaning area and obstacle information corresponding to the cleaning area identified from the space map.

16. The method as claimed in claim 15, further comprising:
based on identifying that the cleaning area is not the travelable area in the space map, identifying an obstacle area including an obstacle based on the obstacle information; and
re-identifying, as the cleaning area, an area excluding the obstacle area from the cleaning area based on the position of the cleaning area and the obstacle area in the space map,
wherein the obstacle area is an area including a second margin area within a pre-set distance from the obstacle.

17. The method as claimed in claim 13, further comprising:
identifying the exploration area including a third margin area within a pre-set distance from the cleaning area;
obtaining sensing data corresponding to an inside of the cleaning area through at least one sensor while traveling a boundary of the exploration area; and
identifying whether the cleaning area is the cleanable area based on the obtained sensing data.

18. The method as claimed in claim 12, further comprising:
based on identifying that the cleaning area is the cleanable area, identifying a first cleaning path based on a pre-set travel pattern; and
causing the robot to clean the liquid contaminant by traveling the cleaning area rearward based on the identified first cleaning path.

19. One or more non-transitory computer-readable storage media storing one or more computer programs including computer-executable instructions that, when executed by one or more processors of a robot individually or collectively, cause the robot to perform operations, the operations comprising:
based on identifying a liquid contaminant, identifying a cleaning area including the liquid contaminant;
based on identifying that the identified cleaning area is a travelable area based on a space map corresponding to a space, obtaining sensing data while traveling the cleaning area;
based on identifying that the cleaning area is a cleanable area based on the obtained sensing data, identifying a cleaning path in the cleaning area; and
causing the robot to perform cleaning along the cleaning path.

20. The one or more non-transitory computer-readable storage media of claim 19, the operations further comprising:
based on identifying that the cleaning area is a travelable area, identifying an exploration area including the cleaning area; and
obtaining the sensing data through at least one sensor while traveling the exploration area.
